(19) United States
(12) Patent Application Publication
(10) Pub. No.: US 2022/0241801 A1
(43) Pub. Date: Aug. 4, 2022

(54) SHOWER HEAD WITH GUNJET

(71) Applicant: XIAMEN SUITEC SANITARY WARES & FITTINGS CO LTD, Xiamen (CN)

(72) Inventors: Jianquan Zhang, Xiamen (CN); Jichang Cai, Xiamen (CN)

(21) Appl. No.: 17/213,300

(22) Filed: Mar. 26, 2021

(30) Foreign Application Priority Data
Feb. 2, 2021 (CN) 202120295264.X

(51) Int. Cl. B05B 1/18; B05B 1/16

(52) U.S. Cl. CPC B05B 1/185; B05B 1/1636

(57) ABSTRACT

Disclosed is a shower head. The shower head comprises a water passing mechanism, a gunjet mechanism, a cover mechanism, a first switcher and a second switcher. The water passing mechanism includes a water inlet pipe and a water passing member. The water inlet pipe and the water passing member are in communication with the first switcher, respectively. The gunjet mechanism includes a jet nozzle which is in communication with the first water passage. The cover mechanism is in communication with the second water passage. The first switcher is configured to switch the water out from the gunjet mechanism or the cover mechanism. The second switcher is configured to switch the water outlet modes of the cover mechanism.

### CROSS REFERENCE OF RELATED APPLICATIONS

The present application claims the benefit of China Patent Application No. 202120295264.X, entitled “SHOWER HEAD WITH GUNJET”, filed on Feb. 2, 2021, in the China National Intellectual Property Administration, the entire content of which is incorporated herein in its entirety.

### TECHNICAL FIELD

The subject matter herein relates to a technical filed of sanitary wares, especially to a shower head with gunjet.

### BACKGROUND

Shower heads are commonly known water outlet device. In normal use, the shower head is not only used for showering, but also used to flush the walls, floor, and toilets. However, in the prior art, the weak pressure and dispersive of outlet water make it hard to clean the walls, floor, and toilets.

At present, there are some showers having water jetting function. However, these shower heads have two switching structures, one is used to switch the water to out from the cover, and the other switching the water to out from a sprayer jet. The existence of the two switching structures makes the shower head thick and heavy, which degrades the appearance of the shower head. In view of this, this disclosure is provided after studying the existing technology.

### SUMMARY

The present disclosure provides a shower head with gunjet, aiming at improving the existing shower head and reducing the thickness of the water outlet part of the shower head.

In view of this, the present disclosure provides a shower head with gunjet. The shower head comprises:

a water passing mechanism, comprising a water inlet pipe and a water passing member; a first water passage and a second water passage are arranged on the water passing member;

a gunjet mechanism, comprising a jet nozzle which is in communication with the first water passage;

a cover mechanism, which is in communication with the second water passage;

a first switcher, comprising a switch body having a switch cavity, a switch shaft sleeved with a sealing member, an elastic member, and a switch seat engaged with the switch body; the elastic member is capable of resetting the switch shaft; the switch shaft is arranged within the switch cavity and has a first extend portion extending out from the switch cavity; the switch shaft is capable of moving in axial direction; the water inlet pipe is in communication with the switch cavity, and a first water outlet port M which is in communication with the first water passage and a second water outlet port N which is in communication with the second water passage are disposed on the switch cavity;

the switch seat is capable of enabling the axial movement of the switch shaft, so that the first water outlet port M or the second water outlet port N is in communication with the water inlet pipe.

In some embodiments, a middle part of the switch seat is engaged with the switch body; one end of the switch body is provided with a second extend portion which is connected to the first extend portion; the switch seat is capable of enabling a reciprocating motion of the switch shaft via a seesaw-like activity.

In some embodiments, the second extend portion is attachable to the first extend portion.

In some embodiments, the first switch mechanism further comprises a guiding shaft; the switch shaft is transversely arranged and comprises a guiding groove which is fitted to the guiding shaft; the guiding shaft is transversely arranged within the guiding groove; each of two ends of the elastic member is abutted against to the switch shaft and the guiding shaft; the switch shaft is capable of moving along the guiding shaft and compressing the elastic member.

In some embodiments, the elastic member is a spring fitted over the guiding shaft.

In some embodiments, the switch body is a split structure, which comprises a first body having the first water outlet port M and a second body having the second water outlet port N; the first body and the second body are assembled together in a sealed manner, to form the switch cavity.

In some embodiments, the shower head further comprises a housing mechanism; the housing mechanism comprises a handheld portion and a water outlet portion; a gunjet nozzle is exposed from a top of the water outlet portion.

In some embodiments, the first switcher further comprises a switch button arranged on the switch seat; the switch button transversely exposed out from a back surface of the water outlet portion.

In some embodiments, the shower head further comprises a second switcher; the second switcher is configured to switch water outlet manners of the cover mechanism.

the cover mechanism comprises a switch disc and a cover assembly for water outlet; at least two independent water outlet sections are located between the switch disc and the cover assembly; each of the water outlet sections is provided with a hole in communication with the second water passage;

the second switcher is capable of, at least, driving a rotation of the switch disc, so that one of the water outlet sections is in communication with the second water passage.

In some embodiments, a first section A, a second section B and a third section C are located between the switch disc and the cover assembly; the second switcher is capable of driving the rotation of the switch disc, so that the water is output from the first section A, the second section B, or the third section C.

In view of the above disclosure, following technical effect may be obtained.

1. The first switch mechanism provides water outlet switching between the gunjet mechanism and the cover mechanism. Both the switch shaft and the switch seat of the first switch mechanism are transversely arranged, which can greatly reduce the space occupied in vertical direction and assure the shower head with gunjet has proper thickness, increasing the appearance of the shower head.

2. The switch seat is engaged with the switch body, and relying on the seesaw-like activity of the switch seat, the switch shaft can be lead to a reciprocating motion to achieve the water outlet switch. Such switch seat is simple and reliable.

### BRIEF DESCRIPTION OF THE DRAWINGS

In order to explain the technical features of the embodiments of the present invention more clearly, the following will briefly introduce the drawings that need to be used in the embodiments. It should be understood that the following drawings only show certain embodiments of the present invention, and therefore it should not be regarded as a limitation of the scope. For those of ordinary skill in the art, other related drawings can be obtained from these drawings without creative work.

FIG. 1 is schematic diagram of the shower head with gunjet according to one embodiment of the present disclosure.

FIG. 2 is a first partially exploded view of the shower head with gunjet according to one embodiment of the present disclosure.

FIG. 3 is a second partially exploded view of the shower head with gunjet according to one embodiment of the present disclosure.

FIG. 4 is a schematic diagram of the switch disc according to one embodiment of the present disclosure.

FIG. 5 is a schematic diagram of the water passing member according to one embodiment of the present disclosure.

FIG. 6 is a schematic diagram of the shower head with part of the housing mechanism being hidden according to one embodiment of the present disclosure.

FIG. 7 is a schematic diagram of the first switcher according to one embodiment of the present disclosure.

FIG. 8 is an exploded diagram of the first switcher according to one embodiment of the present disclosure.

FIG. 9 is a cross-sectional diagram of the first switcher according to one embodiment of the present disclosure.

In the drawings:

100-housing mechanism;

200-water passing mechanism; 210-water inlet pipe; 220-water passing member; 221-first water passage; 222-second water passage;

300-first switcher; 310-switch body; 320-switch shaft; 330-elastic member; 340-guiding shaft; 350-switch seat; 360-switch button; 311-first body; 212-second body; 313-switch cavity; 321-first extending portion; 322-guiding groove; 351-second extending portion;

400-second switcher;

500-gunjet mechanism; 510-jet nozzle;

600-cover mechanism; 610-switch disc; 620-cover assembly;

A-first section; B-second section; C-third section; M-first water outlet port; N-second water outlet port.

### DETAILED DESCRIPTION OF THE INVENTION

In order to make the objectives, technical solutions and advantages of the embodiments of the present invention clearer, the technical solutions in the embodiments of the present invention will be described clearly and completely in conjunction with the accompanying drawings in the embodiments of the present invention. Obviously, the described embodiments It is a part of the embodiments of the present invention, not all the embodiments. Based on the embodiments of the present invention, all other embodiments obtained by those of ordinary skill in the art without creative work fall within the protection scope of the present invention. Therefore, the following detailed description of the embodiments of the present invention provided in the accompanying drawings is not intended to limit the scope of the claimed invention, but merely represents selected embodiments of the present invention. Based on the embodiments of the present invention, all other embodiments obtained by those of ordinary skill in the art without creative work fall within the protection scope of the present invention.

In the description of the present invention, it should be understood that the terms “center”, “longitudinal”, “transverse”, “length”, “width”, “thickness”, “upper”, “lower”, “front”, “back”, “left”, “right”, “vertical”, “horizontal”, “top”, “bottom”, “inner”, “outer”, “clockwise”, “counterclockwise” and other directions or the positional relationship are based on the position or positional relationship shown in the drawings, and are only for the convenience of describing the present invention and simplifying the description, and do not indicate or imply that the pointed device or element must have a specific orientation, be constructed and operated in a specific orientation, Therefore, it cannot be understood as a limitation to the present invention.

In addition, the terms “first” and “second” are only used for descriptive purposes, and cannot be understood as indicating or implying relative importance or implicitly indicating the number of indicated technical features. Thus, the features defined with “first” and “second” may explicitly or implicitly include one or more of these features. In the description of the present invention, “plurality” means two or more than two, unless specifically defined otherwise.

In the present invention, unless otherwise clearly specified and limited, the terms “installed”, “connected”, “connected”, “fixed” and other terms should be understood in a broad sense, for example, it may be a fixed connection or a detachable connection, or integrated; it can be a mechanical connection or an electrical connection; it can be directly connected or indirectly connected through an intermediate medium, and it can be the internal communication of two components or the interaction relationship between two components. For those of ordinary skill in the art, the specific meanings of the above terms in the present invention can be understood according to specific circumstances.

In the present invention, unless otherwise clearly defined and defined, the “on” or “under” of the first feature of the second feature may include direct contact between the first and second features, or may include the first and second features Not in direct contact but through other features between them. Moreover, “above”, “above” and “above” the second feature of the first feature include the first feature being directly above and obliquely above the second feature, or it simply means that the level of the first feature is higher than the second feature. The “below”, “below”, and “below” of the first feature of the second feature include the first feature directly below and obliquely below the second feature, or it simply means that the level of the first feature is smaller than the second feature.

The present disclosure will be further described in detail below with reference to the drawings and specific embodiments.

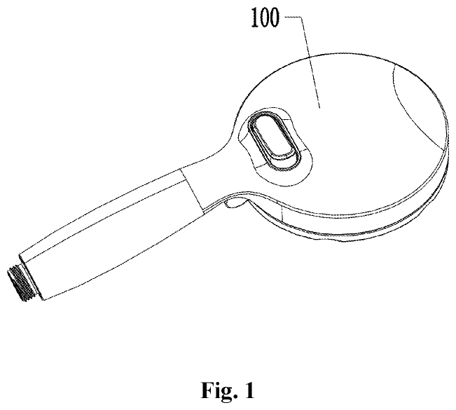

Referring to FIGS. 1-3, the present disclosure provides a shower head with a gunjet. The shower head comprises a housing mechanism 100, a water passing mechanism 200, a gunjet mechanism 500, a cover mechanism 600, a first switcher 300, and a second switcher 400. The gunjet mechanism 500 is configured for water jet; the first switcher 300 is configured to switch the water out from the gunjet mechanism 500 or the cover mechanism 600; the second switcher 400 is configured to switch the water outlet modes of the cover mechanism 600.

More specifically, referring to FIG. 1 to FIG. 3, in the embodiments, the housing mechanism 100 comprises a handheld portion for handheld, and a water outlet portion for water outlet. The gunjet mechanism 500 comprises a jet nozzle 510, and the jet nozzle 510 is exposed to a top of the water out portion.

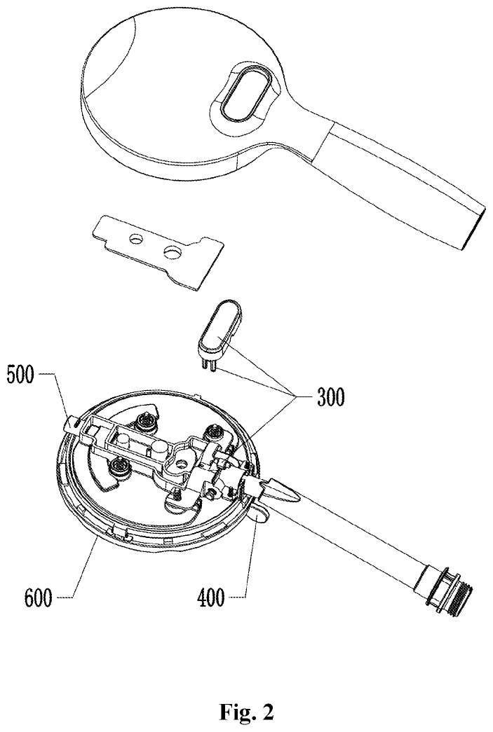

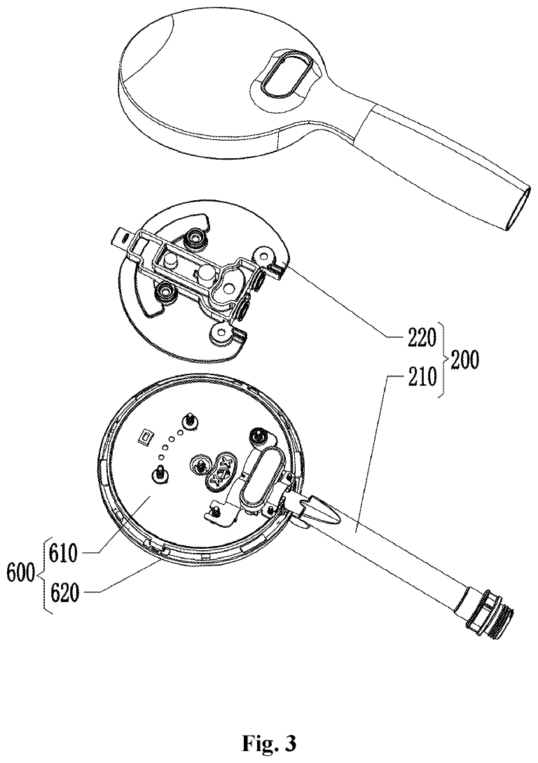

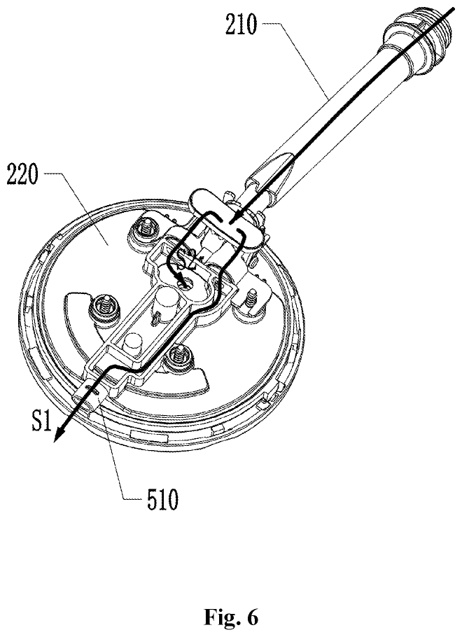

Referring to FIG. 2, FIG. 3 and FIG. 5, in the embodiments, the water passing mechanism 200 comprises a water inlet pipe 210 and a water passing member 220. The water inlet pipe 210 is substantially located within the handheld portion. Outside water may enter the shower head through the water inlet pipe 210. The water passing member 220 comprises a first water passage 221 and a second water passage 222. The jet nozzle 510 is in communication with the first water passage 221. The first switcher 300 is in communication with the water inlet pipe 210 and the water passing member 220. The first switcher 300 is configured to switch the water from the water inlet pipe 210 to the first water passage 221 or the second water passage 222. More specifically, as shown in FIG. 5 and FIG. 6, water from the water inlet pipe 210 may enter the first water passage 221 and be jetted along the trajectory Si from the jet nozzle 510 to form a jetting water after the switch of the first switcher 300. Alternatively, water from the water inlet pipe 210 may enter the second water passage 222 and flow into the cover mechanism 600 along the trajectory S2 to from a cover outlet water. It is to be noted, as shown in FIG. 5, in the embodiments, the gunjet 510 and the water passing member 220 are integrated structure. In another embodiments, the jet nozzle 510 and the water passing member 220 may be separated components. The jet nozzle 510 may be detachably and hermetically attached to the water passing member 220.

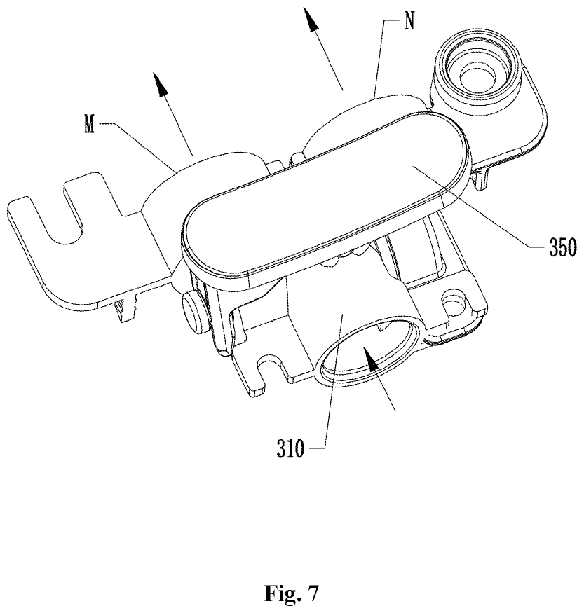

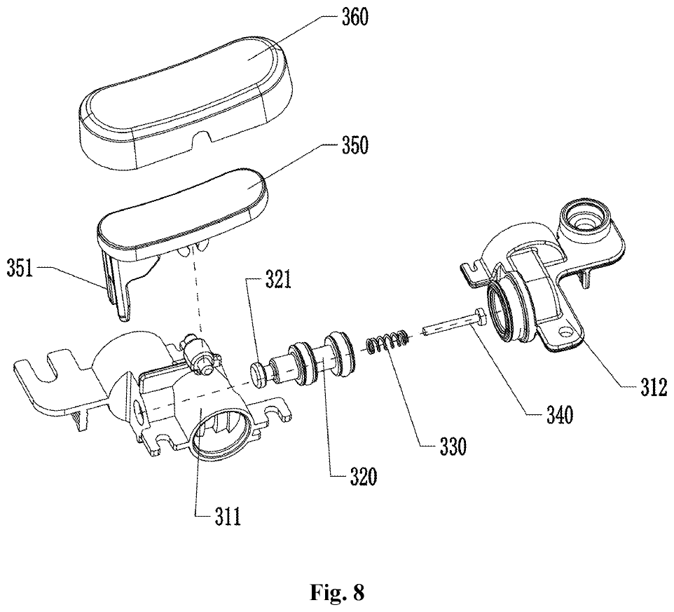

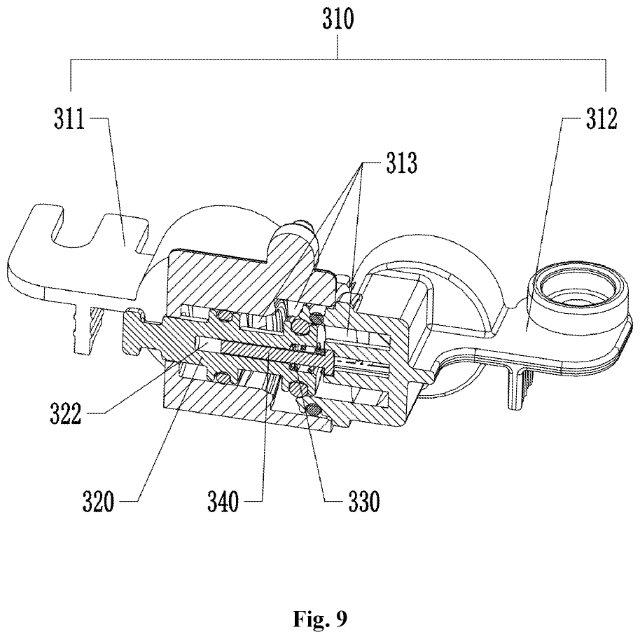

As shown in FIG. 7, FIG. 8 and FIG. 9, in the embodiments, the first switcher 300 comprises a switch body 310 having a switch cavity 313, a switch shaft 320 fitted over a sealing member, a guiding shaft 340, a elastic member 330, a switch seat 350 engaged with the switch body 310, and a switch button 360 which is exposed to the housing mechanism 100 and mounted to the switch seat 350. Surely, in another embodiments, the switch seat 350 and the switch 360 may be an integrated structure.

The switch shaft 320 is movable along its axis and may transversely arranged within the switch cavity 313. The switch shaft 320 is sleeved with two sealing rings. One end of the switch shaft 320 is provided a first extending portion 321 which extends out from the switch cavity 313, the other end of the switch shaft 320 is provided with a guiding groove 322 which is transversely arranged and is adapted to guiding shaft 340.

The guiding shaft 340 is a nail-shaped geometric body, which is laterally and movably inserted into the guiding groove 322. One end of the guiding shaft 340 exposed to the guiding groove 322 is provided with a cap-shaped matching part. The elastic member 330 is a spring fitted over the guiding shaft 340, and two ends of the spring are abutted against the bottom wall of the guiding groove 322 and the mating part of the guiding shaft 340, respectively.

The switch seat 350 is supported on the switch body 310, and the middle part of the switch seat 350 is engaged with the switch body 310. One end of the switch seat 350 is provided with a second extending portion 351 extending downward, and the second extending portion 351 is detachably clamped to the first extending portion 321. The switch button 360 is assembled on the switch seat 350 and is exposed from the housing mechanism 100.

It should be noted that the switch body 310 is provided with a first water outlet port M and a second water outlet port N, the first water outlet port M and the second water outlet port N are both in communication with the switch cavity 313. The first water outlet port M and the second water outlet port N The nozzle N are in communication with the first water passage 221 and the second water passage 222, respectively. The position where the water inlet pipe 210 communicates with the switch cavity 313 is located between the first water outlet port M and the second water outlet port N communicating with the switch cavity 313. In addition, there are two sealing rings fitted over the switch shaft 320, one of the sealing rings is used to seal the switch shaft 320 and the switch cavity 313, preventing the water in the switch cavity 313 from the position where the switch shaft 320 extending out from the switching cavity 313. The other sealing ring may block the first water outlet port M or the second water outlet port N from communicating with the switch cavity 313 along with the axial movement of the switch shaft 320.

As shown in FIG. 8 and FIG. 9, in practice, the switch button 360 may be pressed from left side or right side, so that the switch button 360 may actuate the seesaw movement of switch seat 350. Along with the movement of the switch seat 350, the switch shaft 320 may move within the switch cavity 313 along the axial direction. The cooperation of the guiding groove 322 and the guiding shaft 340 may improve the stability of the axial movement of the switch shaft 320, and the sealing ring of the shaft switch shaft may perform the sealing role well.

When the left side of the switch button 360 is being pressed, the switch seat 350 will cause the switch shaft 320 to move rightward and compress the elastic member. In this occasion, the communication between the second water outlet port N and the switch cavity 313 will be blocked, and the water within the switch cavity 313 has to enter the first water passage 221 through the first water outlet port M and form the water outlet from the jet nozzle 510.

When the right side of the switch button 360 is being pressed, the switch seat 350 will cause the switch shaft 320 to move leftward. In this occasion, the communication between the first water outlet port M and the switch cavity 313 will be blocked, and the water within the switch cavity 313 has to enter the second water passage 222 through the second water outlet port N and form the water outlet from the cover assembly 620. Surely, the water outlet modes of the cover assembly 620 may be controlled by the second switcher 400.

Additionally, it should be noted that when the first switcher 300 is in a state where water is jetted from the jet nozzle 510, the compressed elastic member 330 will reset the switch shaft 320 and the communication between the first water outlet port M and the switch cavity 313 will be blocked when the force applied to the switch button 360 is released.

Additionally, as shown in FIG. 8 and FIG. 9, in the embodiments, the switch body 310 is a split structure, comprising a first body 311 and a second body 312. The first water outlet port M is provided on the first body 311. The second water outlet port N is provided on the second body 312. The first body 311 and the second body 312 are detachably and water-tightly assembled via a sealing ring. The split structure greatly reduce the difficulty of processing the switch body 310. Of course, in other embodiments, the switch body 310 may be an integrated structure.

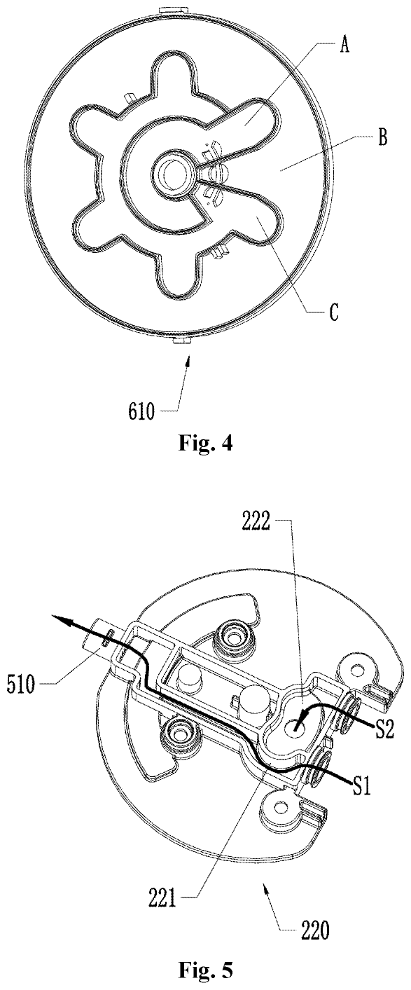

As shown in FIG. 2, FIG. 3 and FIG. 4, in the embodiments, the cover mechanism 600 comprises a switch disc 610 and a cover assembly 620. Three independent water outlet sections, including the first section A, the second section B and the third section C, are formed between the switch disc 610 and the cove assembly 620. Each of the three water outlet sections comprise holes to communicate with the second water passage 222. In practice, the second switcher 400 may rotate the switch disc 610 via a connecting structure, so that one of the three water outlet sections is in communication with the second water passage 222. Furthermore, the first section A, the second section B and the third section C, respectively, correspond to three different water outlet holes, so that different water outlet sections may lead to different type of water outlet. It is to be noted that the cover mechanism 620 and the second switcher 400 are known in the art and will not be repeated here.

Through the embodiments of the present disclosure, the first switcher 300 of the shower head may allow the water outlet from the gunjet mechanism 500 or the cover mechanism 600. Both the switch shaft 320 and the switch seat 350 of the first switcher 300 are transversely arranged, and the switch function of the first switcher 300 is realized by the left and right movement of the switch shaft 320. The first switcher 300 may greatly reduce the space occupied in longitudinal direction, so that the first switcher 300 will not affect the thickness of the shower head and may greatly improve the appearance of the shower head. Additionally, in the first switcher 300, the switch seat 350 is engaged with the switch body 310, and the switch seat 350 cause the movement of the switch shaft 320 via the seesaw-like activity to realize the switch of water outlet. The switch seat 350 has simple and reliable structure, and occupies a little longitudinal space.

It should be noted that the aforementioned embodiments are merely preferred embodiments of the present disclosure, and those embodiments are not to be deemed as limiting the scope of the invention. The scope of the disclosure should be limited by the by the scope of the claims. It will be apparent to those skilled in the art that other modifications and changes may be made without departing from the spirit and scope of the disclosure.

What is claimed is:

1. A shower head with gunjet, comprising:
a water passing mechanism, comprising a water inlet pipe and a water passing member; a first water passage and a second water passage are arranged on the water passing member;
a gunjet mechanism, comprising a jet nozzle which is in communication with the first water passage;
a cover mechanism, which is in communication with the second water passage;
a first switcher, comprising a switch body having a switch cavity, a switch shaft sleeved with a sealing member, an elastic member, and a switch seat engaged with the switch body; the elastic member is capable of resetting the switch shaft; the switch shaft is arranged within the switch cavity and has a first extend portion extending out from the switch cavity; the switch shaft is capable of moving in axial direction; the water inlet pipe is in communication with the switch cavity, and a first water outlet port which is in communication with the first water passage and a second water outlet port which is in communication with the second water passage are disposed on the switch cavity;
the switch seat is capable of enabling the axial movement of the switch shaft, so that the first water outlet port or the second water outlet port is in communication with the water inlet pipe.

2. The shower head according to claim 1, wherein a middle part of the switch seat is engaged with the switch body; one end of the switch body is provided with a second extend portion which is connected to the first extend portion; the switch seat is capable of enabling a reciprocating motion of the switch shaft via a seesaw-like activity.

3. The shower head according to claim 2, wherein the second extend portion is detachably attached to the first extend portion.

4. The shower head according to claim 1, wherein the first switch mechanism further comprises a guiding shaft; the switch shaft is transversely arranged and comprises a guiding groove which is fitted to the guiding shaft; the guiding shaft is transversely arranged within the guiding groove; each of two ends of the elastic member is abutted against to the switch shaft and the guiding shaft; the switch shaft is capable of moving along the guiding shaft and compressing the elastic member.

5. The shower head according to claim 1, wherein the elastic member is a spring fitted over the guiding shaft.

6. The shower head according to claim 1, wherein the switch body is a split structure, which comprises a first body having the first water outlet port M and a second body having the second water outlet port N; the first body and the second body are assembled together in a sealed manner, to form the switch cavity.

7. The shower head according to claim 1, wherein the shower head further comprises a housing mechanism; the housing mechanism comprises a handheld portion and a water outlet portion; a gunjet nozzle is exposed from a top of the water outlet portion.

8. The shower head according to claim 7, wherein the first switcher further comprises a switch button arranged on the switch seat; the switch button transversely exposed out from a back surface of the water outlet portion.

9. The shower head according to claim 1, wherein the shower head further comprises a second switcher; the second switcher is configured to switch water outlet manners of the cover mechanism;
the cover mechanism comprises a switch disc and a cover assembly for water outlet; at least two independent water outlet sections are located between the switch disc and the cover assembly; each of the water outlet sections is provided with a hole in communication with the second water passage;
the second switcher is capable of, at least, driving a rotation of the switch disc, so that one of the water outlet sections is in communication with the second water passage.

10. The shower head according to claim 9, wherein a first section, a second section and a third section are located between the switch disc and the cover assembly; the second switcher is capable of driving the rotation of the switch disc, so that the water is output from the first section, the second section, or the third section.
